(19) United States
(12) Patent Application Publication
(10) Pub. No.: US 2026/0279957 A1
(43) Pub. Date: Sep. 17, 2026

(54) LITHIUM CELL MODULE

(71) Applicant: HOPPECK SYSTEMTECHNIK GMBH, Zwickau (DE)

(72) Inventors: Stefan REINHOLD, Zwickau (DE); Magnus TRAPP, Bad Wünnenberg (DE); Chris Peter RUMMEL, Brilon (DE)

(21) Appl. No.: 19/166,285

(22) PCT Filed: Mar. 21, 2023
(86) PCT No.: PCT/EP2023/057229

§ 371 Date: Sep. 17, 2025

(51) Int. Cl. H01M 10/6556; H01M 10/613; H01M 10/647; H01M 50/209; H01M 50/224; H01M 50/271

(52) U.S. Cl. CPC H01M 10/6556; H01M 10/613; H01M 10/647; H01M 50/224; H01M 50/271; H01M 50/209

(57) ABSTRACT

The disclosure relates to a lithium cell module with a housing and a plurality of lithium cells which are arranged in a row one behind another within the housing in the longitudinal direction of the housing, wherein the housing has a basic body which is U-shaped in cross section and provides a housing base and two side walls arranged thereon, wherein a fluid passage running in the longitudinal direction of the housing is integrated in the housing base.

### CROSS-REFERENCE TO RELATED APPLICATIONS

This application is a U.S. National Phase Application under 35 U.S.C. 371 of International Application No. PCT/EP2023/057229, filed on Mar. 21, 2023.

### FIELD

The disclosure relates to a lithium cell module with a housing and a plurality of lithium cells which are arranged in a row one behind another within the housing in the longitudinal direction of the housing.

### BACKGROUND

This section provides background information related to the present disclosure which is not necessarily prior art.

A lithium cell module of the generic type comprises a housing. A plurality of lithium cells electrically interconnected to each other are arranged within the housing. Typically, the lithium cells are arranged in row one behind another in the longitudinal direction of the housing, in which case several such rows can be provided.

Lithium cell modules of the generic type are used in particular as traction modules for rail traffic. In this case, the focus is especially on railway lines without overhead lines which are served with purely electric trains, which requires battery operation.

Especially lithium cell modules which are used as traction modules require module cooling in order to ensure module operation as intended and to counteract a possible accident as a consequence of excessive heat development. For this reason, lithium cell modules known in prior art have a so-called cooling plate which, like the lithium cells, is accommodated by the housing. The cooling plate can be of a fluid-flowed design, for which purpose the cooling plate has correspondingly formed cooling lines. Water is used as a coolant, i.e. as a cooling fluid, which during the use as intended flows through the cooling lines on the cooling plate side.

Although the above-described designs have proven themselves in everyday practical use, there is room for improvement, particularly with regard to simplified and thus more cost-effective manufacturing as well as a more compact structure.

### SUMMARY

This section provides a general summary of the disclosure, and is not a comprehensive disclosure of its full scope or all of its features.

It is therefore the object of the disclosure to provide a lithium cell module of the generic type which allows a simplified and therefore most cost-effective manufacture as well as a more compact structure.

To achieve this object, a lithium cell module according to claim 1 is proposed.

The housing of the lithium cell module has a basic body which is U-shaped in cross section. This basic body provides a housing base on the one hand and two side walls arranged thereon on the other hand. In the final assembled state, the basic body accommodates the lithium cells of the lithium cell module, wherein the lithium cells are arranged one behind another in a row in the longitudinal direction of the side walls, i.e. in the longitudinal direction of the housing.

In the final assembled state, the lithium cells are accommodated by the housing base of the basic body, i.e. are supported by it. Lateral protection of the lithium cells is ensured by the lateral walls which are arranged on the housing base.

A fluid channel running in the longitudinal direction of the housing is integrated in the housing base. During use of the lithium cell module as intended, this serves as a cooling channel and is flowed through by a fluid which serves as a coolant. The distinctive feature is that the fluid channel is integrated in the housing base of the basic body. Thus, a separate component is completely omitted in the design of a cooling plate. Insofar, the above-mentioned design is of simple structure, which enables simplified and hence less expensive manufacture. In this case, it is particularly beneficial that the space-and cost-optimized integration of the fluid channel serving as a cooling channel in the housing base of the basic body eliminates the need for additional installation of a separate cooling plate.

Another advantage of the above-mentioned design is the structurally optimized cooling in the intended operating case because the thermal transitions between cooling plate and housing are eliminated, and the integrated design of the fluid channel results in an completely cooled base body which enables optimized heat dissipation from the lithium cells, namely via the housing base on the one hand and the two side walls arranged thereon on the other hand. This optimized heat dissipation provides more efficient cooling overall, which enables optimized operation of the lithium cell module while also improving service life.

According to a further feature, it is provided that another fluid channel running in the longitudinal direction of the housing is integrated in the housing base.

The housing base comprises several fluid channels, for example two, three or even more fluid channels, which each run in the longitudinal direction of the housing, i.e. are aligned parallel to each other. The fluid channels are preferably equally spaced to each other in the transverse direction of the housing.

In this context, it it is provided according to the disclosure to provide one fluid channel for each row of lithium cells. Accordingly, one fluid channel is assigned to one row of lithium cells that are arranged one behind another. In the case of several rows of lithium cells arranged one behind another in the longitudinal direction, the number of fluid channels corresponds to the number of rows, so that each row of lithium cells is assigned one fluid channel. As a result, optimized cooling of the lithium cells is ensured.

According to another feature, it is provided that a cross channel which connects the fluid channels to each other in terms of fluid flow is integrated in the housing base. In this way, a closed channel system is provided, wherein in the intended use case, fluid can flow from fluid channel to fluid channel, namely via the cross channels by means of which the fluid channels are coupled to each other in terms of fluid flow. In the simplest embodiment, two parallel fluid channels are provided which are connected to each other in terms of fluid flow via one common cross channel. In this case, fluid that is supplied through one fluid channel can be transferred to the other fluid channel and vice versa via the cross channel.

According to another feature, it is provided that a channel comprises a channel groove which is U-shaped in cross section and a cover closing the open longitudinal side of the channel groove.

According to the above-mentioned feature, a channel is formed by a closed channel groove. The channel groove itself is preferably U-shaped in cross section. Of course, other geometrical designs are conceivable. The channel groove is open along one of its longitudinal sides, independently of its geometric design. This open longitudinal side is designed to be closed to create a channel, for which purpose a channel groove cover is used. In the final assembled state, a channel groove is closed in a fluid-tight manner by its cover, whereby a channel is formed which is integrated in the housing base of the basic body as according to the disclosure.

The channel design by means of a closed design of the channel groove proves to be particularly simple and therefore also cost-effective to manufacture. It is preferable to form the channel groove in the basic body in one piece in a first manufacturing step. Then, in a second manufacturing step, the only thing left to do is to close the open side of the channel groove, resulting in a channel, be it a fluid channel or a cross channel.

According to another feature, it is provided that the basic body is a bent sheet metal part.

According to a first alternative, the basic body is formed from a sheet metal part, for example, a metal sheet or plate. This is reshaped by bending to form the basic body. As a result, the basic body is formed as a bent sheet metal part.

Forming the basic body as a bent sheet metal part has the particular advantage of simplified and inexpensive manufacture. Because it is possible to form the side walls which are angled relative to the housing and also to form the channel grooves in the housing base by simply reshaping a metal sheet by bending.

According to another feature, it is provided that the basic body is an extruded profile.

According to this alternative design, the basic body is formed by an extruded profile. This method of manufacturing the basic body is also simple and therefore cost-effective. In addition, a one-piece basic body can be manufactured in a single step, which basic body has a housing base and two side walls arranged thereon as well as channel grooves formed in the housing base, as already described.

According to another feature, it is provided that a channel groove is formed by milling.

According to this alternative, the channel groove is formed using milling. In this case, the basic body can be designed as a bent part or as an extruded profile or in any other way, however, without channel grooves on the housing base side. These are formed separately, preferably by milling.

Forming a channel groove by milling has the particular advantage that it is possible in a simple way to form a channel groove which has a shoulder on the cover side. In this respect, the channel groove has a staircase structure in cross section. The shoulder further serves to receive a channel groove cover which then engages positively with a shoulder configuration in the final assembled state. This design has the particular advantage that the housing base is flat on its underside facing away from the lithium cells. This is because the groove covers are each arranged in the groove widening formed by the shoulder design.

According to another feature of the disclosure, it is provided that the cover is a strip which is formed corresponding to the channel groove to be closed. In the final assembled state, this strip is inserted into the groove widening formed as a result of the shoulder design, whereby the channel groove is closed on the one hand and a flush termination with the underside of the housing base opposite the lithium cells is achieved on the other hand. For the purpose of a permanent connection of the cover to the housing base, the cover can be connected to the housing base especially cohesively, for instance by welding, or quasi positively, for instance by adhesive bonding. Of course, other types of connection of cover and housing base are also conceivable.

According to an alternative design, which is not part of the invention, it is provided that the cover is a plate which closes a plurality of channel grooves jointly.

According to this alternative, the housing base is quasi doubled. For this purpose, a plate is used which is arranged on the underside of the housing base opposite the lithium cells. This will close the channel grooves provided on the side of the housing base, wherein the plate covers all channel grooves jointly. For the purpose of a permanent connection between the basic body and the plate, the basic body and the plate can be connected to each other by welding, adhesive bonding or otherwise.

According to another feature of the disclosure, it is provided that the channel grooves are formed in the large side, i.e. underside of the basic body facing away from the lithium cells. Alternatively, also the large side facing the lithium cells, i.e. the upper side of the basic body, can be provided with longitudinal grooves. However, according to the disclosure, the underside has to be provided with corresponding channel grooves, so that a continuous, i.e. uninterrupted and flat surface is created on the side of the lithium cells, on which surface the lithium cells are supported for optimized dissipation of heat. A combined design is also possible, i.e. a design in which channel grooves are formed in the far large side and also in the near large side. In particular, it can be provided to form channel grooves on the large side facing away from the lithium cells, for creating fluid channels, whereas channel grooves are formed in the large side facing the lithium cells, for creating cross channels.

According to another feature of the disclosure, it is provided that the large side facing the lithium cells, i.e. the upper side of the basic body, and/or the large side facing away from the lithium cells, i.e. the underside of the basic body, is flat. This flat design of the large sides enables optimized heat transfer and also ensures gap-free accommodation of the lithium cells by the basic body on the one hand and improved stackability of several lithium cell modules on top of each other on the other.

According to another feature of the disclosure, it is provided that a fluid channel is in communication with a fluid inlet connection and/or a fluid outlet connection in terms of fluid flow.

In accordance with the intended use, a coolant, such as water, is fed into the fluid channel via the fluid inlet connection. After passing through the fluid channel, the coolant leaves the channel via the fluid outlet connection provided for this purpose.

Preferably, a basic body is equipped with several fluid channels and/or cross channels that form a channel system. This channel system is connected to the fluid inlet and fluid outlet connections. For this purpose, it may be provided, for example, that a first fluid channel is equipped with a fluid inlet connection, while another fluid channel provides the fluid outlet connection. The two fluid channels are connected to each other in terms of fluid flow via a cross channel in such a way that coolant can be fed into the fluid system via one fluid channel, which coolant, after passing through the fluid system, leaves the system via the other fluid channel thanks to the fluid outlet connection provided by the latter.

If, in the intended use, a plurality of lithium cell modules according to the disclosure are used, these are supplied with coolant at the same time, whereby the cell modules are supplied with coolant in parallel. This ensures that all cell modules are cooled at the same time. However, such simultaneous cooling cannot be achieved if the fluid systems of the individual cell modules are connected in series.

According to another feature, it is provided that the housing has end plates which close the basic body on the end face, wherein a row of lithium cells arranged one behind another in the longitudinal direction of the housing is positioned between two end plates.

End plates are used to close the basic body which is formed with a U-shaped cross section on the end face. In this case, one end plate is provided on each of the end faces. In the final assembled state, the basic body is closed on the end face by said two end plates.

In the final assembled state, the two end plates receive the lithium cells which are arranged one behind another to form a row. In this case, the end plates serve as an abutment for the lithium cells and provide for a clamped arrangement of the lithium cells between the end plates. The end plates for their part are supported against the basic body, which enables a corresponding force flow between the end plates via the basic body. Secure positioning of the lithium cells within the basic body is thus ensured. Furthermore, the cell stack is pressed with the end plates in a defined manner to ensure an extended service life of the cells.

According to another feature of the disclosure, it is provided that the housing has a cover which is detachably fixed to the basic body. In the final assembled state, the cover serves to cover the lithium cells on the pole side. Accordingly, in the final assembled state, the lithium cells are completely encased by the housing. The cover is detachably arranged on the basic body of the housing, whereby selective access to the lithium cells is advantageously enabled.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

Further features and advantages of the disclosure will become apparent from the following descriptions with reference to the drawings.

FIG. 1 shows a schematic perspective view of a lithium cell module according to the disclosure;

FIG. 2 shows a schematic perspective view of a lithium cell module according to FIG. 1 from below, with the channel grooves not yet closed;

FIG. 3 shows a schematic perspective view of the lithium cell module according to FIG. 2, with the channel grooves closed;

FIG. 4 shows a schematic perspective view of a lithium cell module according to a second embodiment of the disclosure;

FIG. 5 shows a schematic perspective view of the lithium cell module according to FIG. 4 from below; and

FIG. 6 shows a schematic perspective view of the basic bodies of the lithium cell module according to FIGS. 4 and 5.

### DETAILED DESCRIPTION

Example embodiments will now be described more fully with reference to the accompanying drawings.

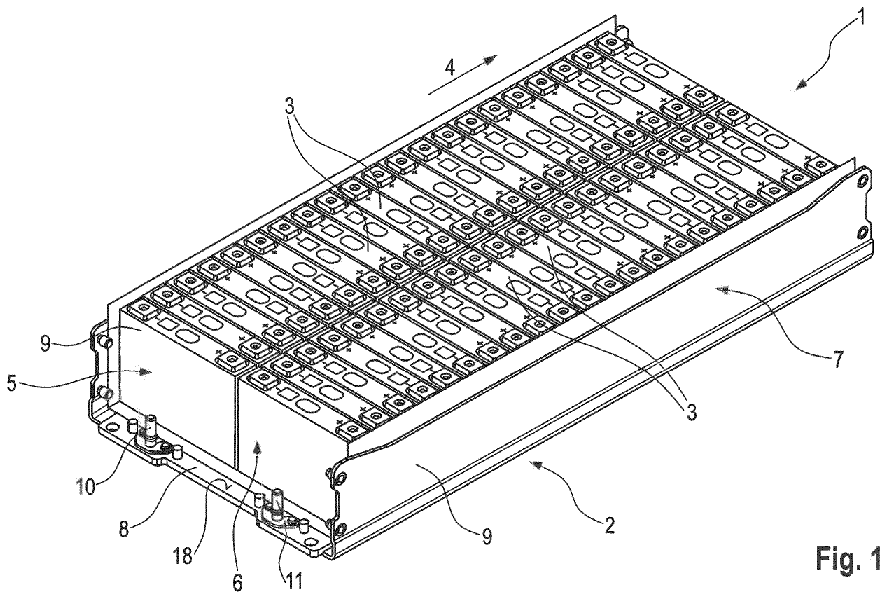

FIG. 1 shows a lithium cell module 1 in a schematic perspective view from above.

The lithium cell module 1 comprises a housing 2 and a plurality of lithium cells 3 arranged within the housing 2. As shown by the illustration according to FIG. 1, the lithium cells 3 are arranged one behind another in a row in the longitudinal direction of the housing. In this case, the housing 2 in the illustrated embodiment accommodates two rows of lithium cells 3, namely a first cell row 5 and a second cell row 6.

The housing 2 has a basic body 7. This is U-shaped in cross section and comprises a housing base 8 and two side walls 9 arranged thereon. In the final assembled state, the open end faces of the basic body 7 are closed by end plates not further illustrated in the Figures. The end plates receive cell rows 5 and 6 between them. Furthermore, the housing 2 has a cover which, too is not further illustrated in the Figures. Preferably, the cover is attached to the basic body 7 in a replaceable manner and covers the lithium cells 3 on the pole side.

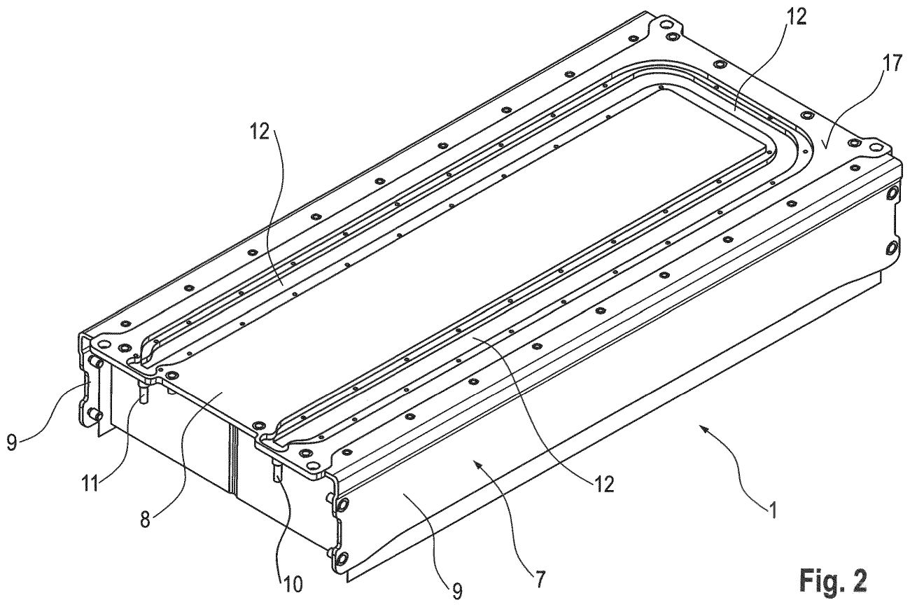

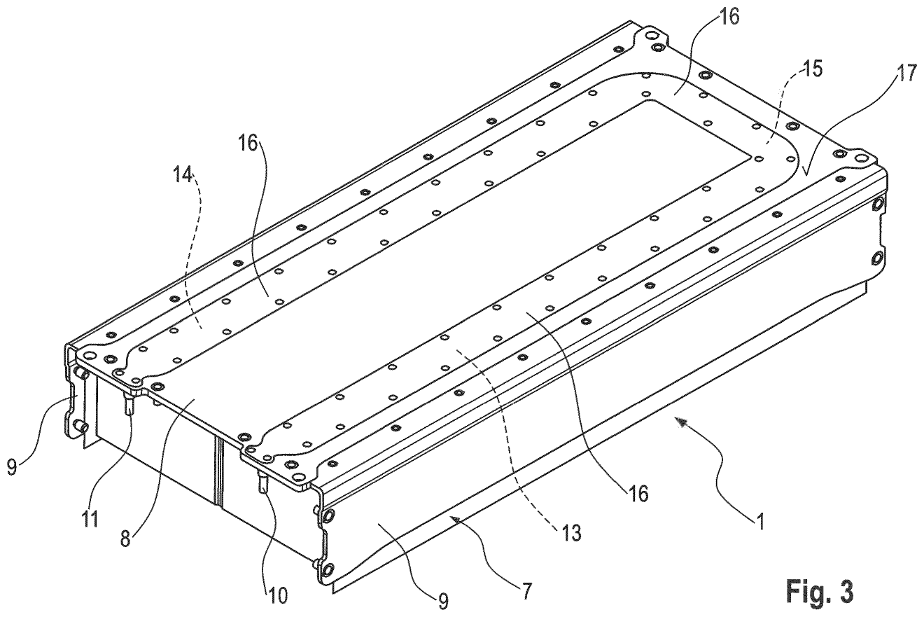

According to the disclosure, a fluid channel 13 or 14 running in the longitudinal direction 4 of the housing is integrated in the housing base 8. In the intended use, this fluid channel 13 or 14 serves as a cooling channel through which a coolant is passed. The coolant may be water, for example. The configuration of the fluid channel 13 or 14 is apparent in particular from the illustrations according to FIGS. 2 and 3.

According to the embodiment shown in the Figures, two fluid channels 13 and 14 are integrated in the housing base 8 of the basic body 7. Furthermore, a cross channel 15 is provided which is integrated in the housing base 8 and which connects the two fluid channels 13 and 14 to each other in terms of fluid flow. This context is apparent in particular from the illustration according to FIG. 3.

As apparent from a combined view especially of FIGS. 1 and 3, the fluid channel 13 is connected to a fluid inlet connection 10. The fluid channel 14 is in fluid communication with a fluid outlet connection 11. In the intended use, a coolant can be supplied to the fluid inlet connection 10, which fluid flows through the cross channel 15 and then through the fluid channel 14 to the fluid outlet connection 11. The coolant then leaves the channel system formed from the fluid channels 13 and 14 and the cross channel 15 via the fluid outlet connection 11.

For forming the channels 13, 14, and 15, the housing base 8 is provided on its large side 17 facing away from the lithium cells 3, i.e. its underside, with channel grooves 12. This is apparent in particular from the illustration according to FIG. 2. In the final assembled state, these channel grooves 12 are closed by means of corresponding covers 16, namely in a fluid-tight manner, so that the fluid channels 13 and 14 or the cross channel 15 already described above are created.

The channel grooves 12 can be formed by milling, for example. Alternatively, the channel grooves 12 can be created by reshaping the basic body 7, for example by bending, punching and/or similar. Alternatively, the housing base 8 can be in the form of an extruded part and can provide the channel grooves 12 in a one-piece design. For reasons of simplified and inexpensive manufacture, a combination of the above-mentioned alternatives is preferable. The basic body 7 can be formed as a bent sheet metal part, for example, with the channel grooves 12 forming the later fluid channels 13 and 14 being formed by bending. However, the channel groove 12 for the later cross channel 15 is formed using milling.

In the illustrated embodiment, strip-like covers 16, for example, serve to cover the channel grooves 12, and one associated cover 16 is provided for each one of the channel grooves 12. The covers 16 can also be of a one-piece design, such as shown in FIG. 3. In the final assembled state, the large side 17 of the housing base 8 opposite the lithium cells 3 is formed flat. From the constructional side, this is achieved by each channel groove 12 being provided on the side of the groove opening with shoulder edges running in the longitudinal direction. Accordingly, due to the shoulder design, the receiving grooves 12 are widened in the transverse direction on the groove opening side. In the final assembled state, the cover strip 16 provided for each one of the channel grooves 12 comes to lie in this widening while it is supported against the shoulder edges. The shoulder edges have a geometric design in the vertical direction that corresponds to the thickness of a cover 16. As a result, the covers 16 are held in place in such a way that they are flush with the large surface 17 provided by the housing base 8.

The large surface 18 of the housing base 8 facing the lithium cells 3 is also flat, so that the lithium cells 3 rest on this large side 18 over their entire surface when finally assembled. Since the channel grooves 12 are formed on the large side 17 facing away from the lithium cells 3, the large side 18 facing the lithium cells 3 has an uninterrupted design, which allows for optimized heat transfer from the lithium cells 3 to the basic body 7.

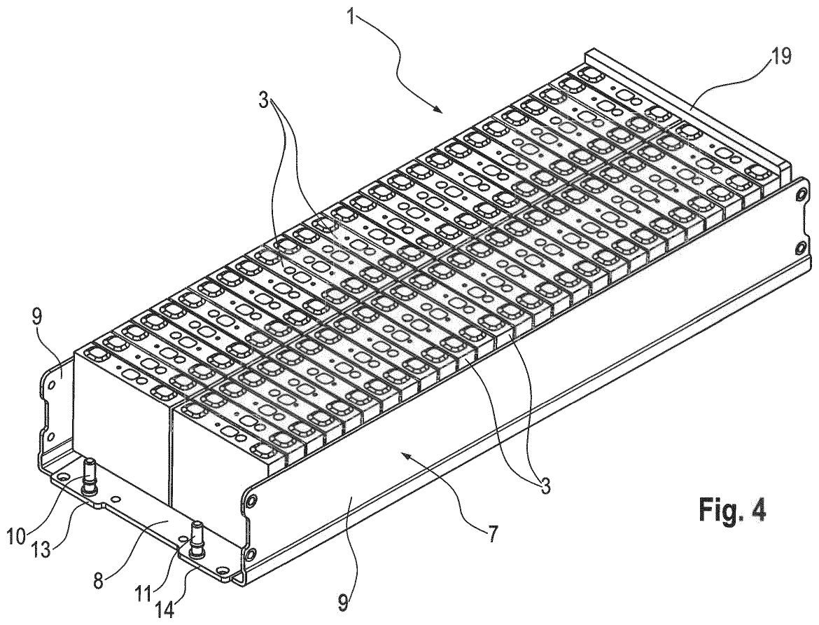

FIGS. 4, 5, and 6 show an alternative embodiment of a lithium cell module 1 according to the disclosure.

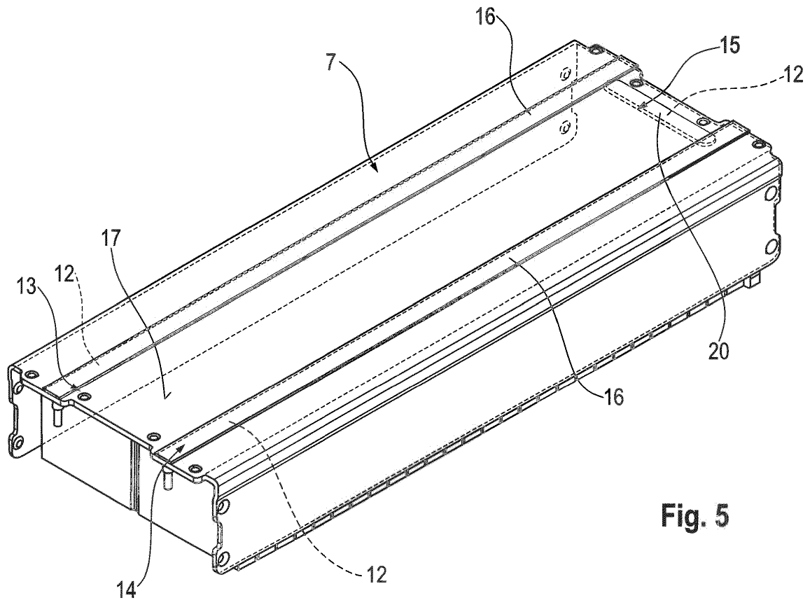

The basic body 7 of the housing 2 of the lithium cell module 1 according to FIGS. 4 to 6 is designed as an extruded profile. The channel grooves 12 for the fluid channels 13 and 14 are embossed in one piece into the housing base 8 of the basic body 7. The channel grooves 12 of the fluid channels 13 and 14 are formed in the large side 17 facing away from the lithium cells 3, i.e., the underside of the basic body 7, as can be seen in particular from FIG. 5. To close the channel grooves 12, correspondingly shaped covers 16 in the form of strips are provided, which close the channel grooves 12 of the fluid channels 13 and 14. The fluid channels 13 and 14 are also closed on the end face, for example by welding. Coolant is supplied and removed in the manner already described via the fluid inlet connections 10 and 11, as can be seen, for example, in FIG. 4. Opposite the fluid inlet and outlet connections 10 and 11, there is a cross channel 15 that connects the fluid channels 13 and 14 in terms of fluid flow. This cross channel 15 is formed by a channel groove 12 closed by a cover 16.

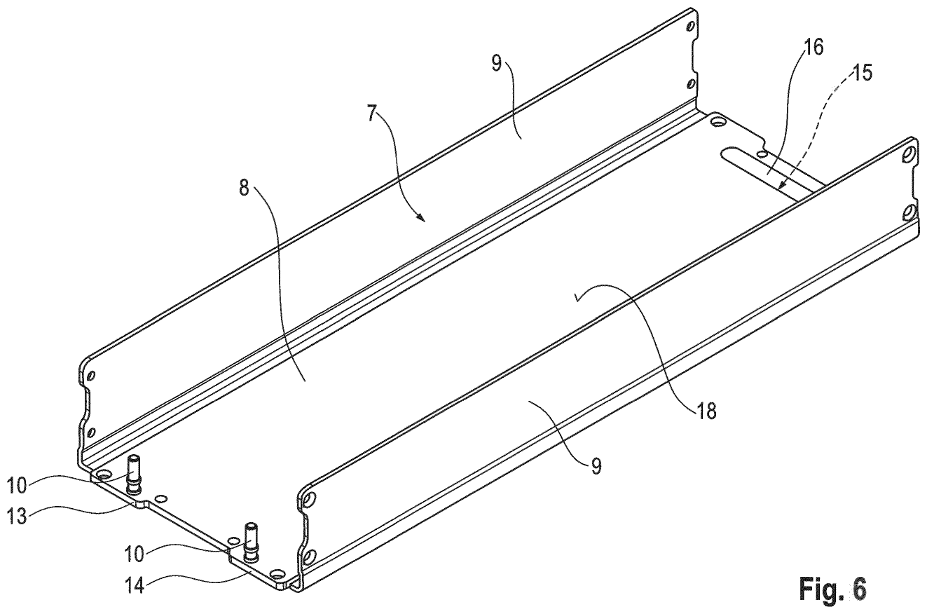

The channel groove 12 of the cross channel 15 is formed by milling. The channel groove 12 forming the cross channel 15 is integrated in the large side 18 facing the lithium cells 3, i.e., the upper side of the basic body 7, as can be seen from a combined view of FIGS. 5 and 6. The upper closure of the channel groove 12 forming the cross channel 15 is provided by the cover 16 in the form of a strip which is supported on a shoulder 20 formed by milling. This shoulder 20 is particularly apparent from the illustration in FIG. 5.

When finally assembled, the basic body 7 is closed on the end face by means of corresponding end plates, FIG. 4 showing, by way of example, the rear end plate 19 according to the drawing plane in FIG. 4.

The foregoing description of the embodiments has been provided for purposes of illustration and description. It is not intended to be exhaustive or to limit the disclosure. Individual elements or features of a particular embodiment are generally not limited to that particular embodiment, but, where applicable, are inter-changeable and can be used in a selected embodiment, even if not specifically shown or described. The same may also be varied in many ways. Such variations are to be regarded as a departure from the disclosure, and all such modifications are intended to be included within the scope of the disclosure.

1. A lithium cell module comprising a housing and a plurality of lithium cells which are arranged in a row one behind another within the housing in the longitudinal direction of the housing, wherein the housing accommodates a first cell row and a second cell row, wherein the housing has a basic body which is U-shaped in cross section and provides a housing base and two side walls arranged thereon, wherein the open end faces of the basic body are closed by end plates receiving the cell rows between them, wherein for each cell row, a fluid passage running in the longitudinal direction of the housing is integrated in the housing base, wherein the housing base, for forming the fluid channels, is provided on its large side facing away from the lithium cells with channel grooves that are closed by corresponding covers in a fluid-tight manner, wherein a cover is a strip designed corresponding to the channel groove to be closed, wherein each channel groove has shoulder edges running in the longitudinal direction on the side of the groove opening, whereby the channel grooves are widened in the transverse direction on the side of the groove opening, wherein the cover provided for each of the channel grooves comes to lie in this widening and is supported against the shoulder edges, wherein the shoulder edges have a geometrical shape in the vertical direction which corresponds to the thickness of the cover.

2. (canceled)

3. The lithium cell module according to claim 1, wherein a cross channel that connects the two flow channels to each other in terms of fluid flow is integrated in the housing base.

4. (canceled)

5. The lithium cell module according to claim 1, wherein the basic body is a bent sheet metal part.

6. The lithium cell module according to claim 1, wherein the basic body is an extruded profile.

7. The lithium cell module according to claim 1, wherein a channel groove is formed by milling.

8. The lithium cell module according to claim 1, wherein the large side of the basic body facing the lithium cells is formed flat.

9. The lithium cell module according to claim 1, wherein a fluid channel is in communication with a fluid inlet connection and/or fluid outlet connection in terms of fluid flow.

10. The lithium cell module according to claim 1, wherein the housing has a cover which is detachably arranged on the basic body.

11-15. (canceled)
